(19) United States
(12) Patent Application Publication
(10) Pub. No.: US 2022/0241924 A1
(43) Pub. Date: Aug. 4, 2022

(54) CONTACT DETECTION METHOD

(71) Applicant: National University Corporation Tokai National Higher Education and Research System, Nagoya-shi (JP)

(72) Inventors: Eiji SHAMOTO, Nagoya-shi (JP); Takehiro HAYASAKA, Nagoya-shi (JP)

(21) Appl. No.: 17/671,339

(22) Filed: Feb. 14, 2022

Related U.S. Application Data
(63) Continuation of application No. PCT/JP2021/003461, filed on Feb. 1, 2021.

(51) Int. Cl. B23Q 17/09; B23Q 17/00

(52) U.S. Cl. CPC B23Q 17/0952; B23Q 17/005

(57) ABSTRACT

A control device acquires first detection values related to control of a motor at a plurality of positions on a first path by moving an object or a tool along the first path with the object and the tool prevented from coming into contact with each other, acquires second detection values related to the control of the motor at a plurality of positions on a second path substantially parallel to the first path by moving the object or the tool along the second path to bring the object and the tool into contact with each other, derives a difference value between the first detection value and the second detection value acquired at each of corresponding positions on the first path and the second path, and detects contact between the tool and the object based on changes in the difference values derived for the plurality of positions.

### CROSS REFERENCE TO RELATED APPLICATIONS

This application is based upon and claims the benefit of priority from International Application No. PCT/JP2021/003461, filed on Feb. 1, 2021, the entire contents of which are incorporated herein by reference.

### BACKGROUND

### 1. Field of the Disclosure

The present disclosure relates to a technique for enabling a machining apparatus to perform cutting with high accuracy.

### 2. Description of the Related Art

In the related art, in order to set an origin point for a machining apparatus, a position of a cutting edge of a cutting tool is measured with a measuring instrument and then adjusted. Alternatively, a workpiece is first machined with a cutting tool, a shape of the workpiece subjected to the machining is measured with a measuring instrument, and a position of a cutting edge is corrected based on the measurement result. The above methods are both origin setting methods using a measuring instrument.

WO 2020/174585 A discloses a technique for specifying a contact position between a cutting tool and a workpiece from first time-series data of detection values related to a drive motor acquired before contact and second time-series data of detection values related to the drive motor acquired after the contact. The contact between the cutting tool and the workpiece is specified by using a regression equation obtained by regression analysis of the second time-series data.

In order to enable a machining apparatus to perform machining with high accuracy, it is necessary to accurately measure a relative positional relationship between an axis or axis end of a rotary spindle and, for example, a table on which a workpiece is secured or an object placed on the table before the machining. In order to accurately measure the positional relationship, it is necessary to implement a function of detecting contact between a tool attached to the rotary spindle and the table or the object placed on the table with high accuracy.

### SUMMARY

The present disclosure has been made in view of such circumstances, and it is therefore an object of the present disclosure to provide a technique for enabling a machining apparatus to perform cutting with high accuracy.

In order to solve the above-described problems, a positional relationship measurement method according to one aspect of the present disclosure is a method for measuring a relative positional relationship between an axis of a spindle and an object, the method including a moving step of moving a tool attached to the spindle relative to the object to bring the object and the tool into contact with each other, a coordinate value acquiring step of acquiring a coordinate value of a reference point when the object and the tool come into contact with each other, and a measuring step of deriving the relative positional relationship between the axis and the object from the coordinate value thus acquired. The moving step brings the object and the tool into contact with each other with the spindle set at different angular positions, the coordinate value acquiring step acquires the coordinate value of the reference point when the object and the tool come into contact with each other with spindle set at the different angular positions, and the measuring step derives the relative positional relationship between the axis and the object from the plurality of coordinate values thus acquired.

A machining apparatus according to another aspect of the present disclosure includes a rotation mechanism structured to rotate a spindle to which a tool is attached, a feed mechanism structured to move the tool relative to an object, and a control device structured to control the rotation of the spindle by the rotation mechanism and the relative movement of the tool by the feed mechanism. The control device brings the object and the tool into contact with each other with the spindle set at different angular positions, acquires the coordinate value of the reference point when the object and the tool come into contact with each other, and derives the relative positional relationship between the axis and the object from the plurality of coordinate values thus acquired.

A contact detection method according to still another aspect of the present disclosure is a method for detecting contact between a tool attached to a spindle and an object, the method including a first acquiring step of acquiring first detection values related to control of a motor included in a feed mechanism at a plurality of positions on a first path by moving the object or the tool along the first path with the object and the tool prevented from coming into contact with each other, a second acquiring step of acquiring second detection values related to the control of the motor included in the feed mechanism at a plurality of positions on a second path substantially parallel to the first path by moving the object or the tool along the second path to bring the object and the tool into contact with each other, a deriving step of deriving a difference value between the first detection value and the second detection value acquired at each of corresponding positions on the first path and the second path, and a detecting step of detecting contact between the tool and the object based on changes in the difference values derived for the plurality of positions.

A machining apparatus according to still another aspect of the present disclosure includes a feed mechanism structured to move a tool relative to an object and a control device structured to control the relative movement of the tool by the feed mechanism, and the control device acquires first detection values related to control of a motor included in the feed mechanism at a plurality of positions on a first path by moving the object or the tool along the first path with the object and the tool prevented from coming into contact with each other, acquires second detection values related to the control of the motor included in the feed mechanism at a plurality of positions on a second path substantially parallel to the first path by moving the object or the tool along the second path to bring the object and the tool into contact with each other, derives a difference value between the first detection value and the second detection value acquired at each of corresponding positions on the first path and the second path, and detects contact between the tool and the object based on changes in the difference values derived for the plurality of positions.

Note that any combination of the above-described components, or an entity that results from replacing expressions of the present disclosure among a method, an apparatus, a system, a recording medium, a computer program, and the like is also valid as an aspect of the present disclosure.

### BRIEF DESCRIPTION OF THE DRAWINGS

FIG. 1 is a diagram showing a schematic structure of a machining apparatus;

FIG. 2 is a diagram showing a shape of a tip of a dummy tool;

FIG. 3 is a diagram showing functional blocks of a control device;

FIG. 4 is a diagram showing an example of a flowchart for detection of contact between the dummy tool and a reference block;

FIG. 5 is a diagram for describing step S10;

FIG. 6 is a diagram for describing step S12;

FIG. 7 is a diagram showing a difference waveform obtained as a result of subtracting a first torque waveform from a second torque waveform;

FIG. 8 is a diagram showing a state where the dummy tool is attached to a holder;

FIG. 9 is a diagram showing an example of a flowchart for measurement of a relative positional relationship between an axis of a spindle and the reference block;

FIG. 10A is a diagram showing how first contact is made, and FIG. 10B is a diagram showing how second contact is made;

FIG. 11A is a diagram showing how first contact is made, and FIG. 11B is a diagram showing how second contact is made; and

FIG. 12 is a diagram showing how a base portion of a rotary tool is brought into contact with a reference surface.

### DETAILED DESCRIPTION

The disclosure will now be described by reference to the preferred embodiments. This does not intend to limit the scope of the present disclosure, but to exemplify the disclosure.

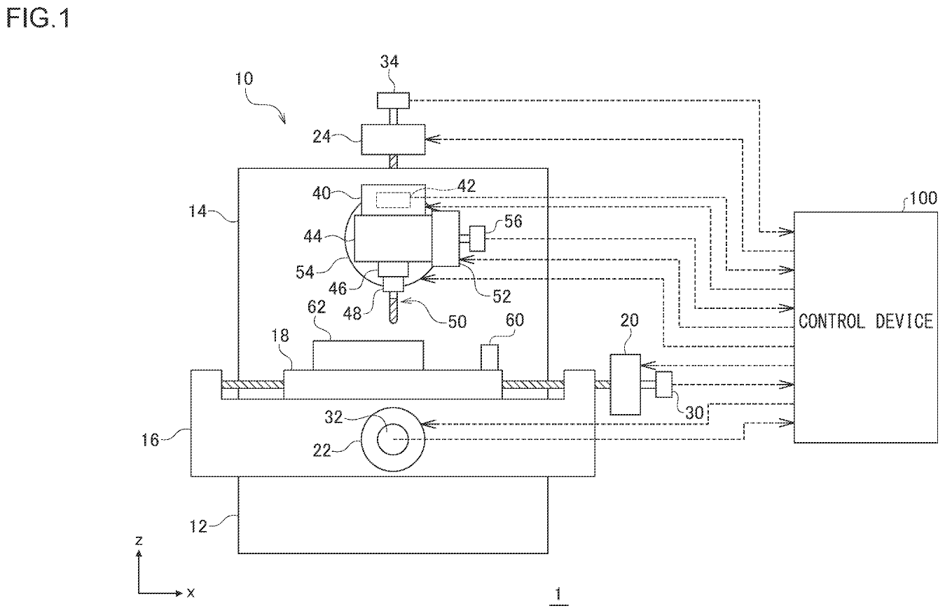

FIG. 1 is a diagram showing a schematic structure of a machining apparatus 1 according to an embodiment. The machining apparatus 1 includes a machine tool 10 and a control device 100. The control device 100 may be a numerical control (NC) control device that controls the machine tool 10 in accordance with an NC program, and the machine tool 10 may be an NC machine tool controlled by the NC control device. In the machining apparatus 1, the machine tool 10 and the control device 100 are separate from each other and connected by a cable or the like, or alternatively may be inseparable from each other.

The machine tool 10 includes a bed 12 and a column 14 that make up a body. On the bed 12, a first table 16 and a second table 18 are supported in a movable manner. The first table 16 is supported by a rail provided on the bed 12 so as to be movable in a Y-axis direction, and the second table 18 is supported by a rail provided on the first table 16 so as to be movable in an X-axis direction. Provided on an upper surface of the second table 18 is a workpiece installation surface, and a workpiece 62 to be machined is secured to the workpiece installation surface.

A Y-axis motor 22 rotates a ball screw mechanism to move the first table 16 in the Y-axis direction, and an X-axis motor 20 rotates a ball screw mechanism to move the second table 18 in the X-axis direction. A Y-axis sensor 32 detects a position of the first table 16 in the Y-axis direction, and an X-axis sensor 30 detects a position of the second table 18 in the X-axis direction.

Provided above the second table 18 is a spindle 46 to which a cutting tool 50 is attached. A spindle motor 40 serves as rotation mechanism that rotates the spindle 46, and a spindle sensor 42 detects an angular position of the spindle 46. The angular position of the spindle 46 is an angular position in a direction in which the spindle 46 rotates and is detected as a rotational angular position relative to a predetermined origin point. Note that the rotation mechanism may include a speed reduction mechanism including a plurality of gears. The spindle 46 and the spindle motor 40 are secured to a spindle support 44. According to the embodiment, a holder 48 is secured to the spindle 46, and an end mill that is the cutting tool 50 is attached to the holder 48. In the machine tool 10, it is preferable that the holder 48 be adapted to an automatic tool changer to allow the cutting tool 50 to be automatically changed in a manner that depends on a type of machining.

The spindle support 44 has a back surface supported by a rail provided on the column 14 so as to be movable in a Z-axis direction. A Z-axis motor 24 rotates a ball screw mechanism to move the spindle 46 in the Z-axis direction. A Z-axis sensor 34 detects a position of the spindle 46 in the Z direction.

A first tilt motor 52 rotates a gear mechanism to tilt the spindle support 44 about an axis orthogonal to the axis of the spindle 46 and the Y axis. A tilt sensor 56 detects an angle of the spindle 46 tilted by the first tilt motor 52. A second tilt motor 54 rotates a gear mechanism to tilt the spindle support 44 about an axis parallel to the Y axis. A tilt sensor (not illustrated) different from the tilt sensor 56 detects an angle of the spindle 46 tilted by the second tilt motor 54.

The control device 100 drives and controls the X-axis motor 20, the Y-axis motor 22, the Z-axis motor 24, the first tilt motor 52, the second tilt motor 54, and the spindle motor 40 in accordance with the NC program. The control device 100 acquires respective detection values detected by the X-axis sensor 30, the Y-axis sensor 32, the Z-axis sensor 34, the tilt sensor, and the spindle sensor 42 and applies each of the detection values to drive control of a corresponding motor.

In the machine tool 10 shown in FIG. 1, the workpiece 62 is moved in the X-axis direction and the Y-axis direction by the X-axis motor 20 and the Y-axis motor 22, and the cutting tool 50 is moved in the Z-axis direction by the Z-axis motor 24, but such movements may be relative movements between the cutting tool 50 and the workpiece 62. That is, in the machine tool 10, the cutting tool 50 may be moved in the X-axis direction and the Y-axis direction, and the workpiece 62 may be moved in the Z-axis direction. In the machine tool 10, the cutting tool 50 is tilted by the first tilt motor 52 and the second tilt motor 54 relative to the workpiece 62, but such tilt motors may be provided in the bed 12.

As described above, it is not important which of the cutting tool 50 and the workpiece 62 is moved as long as the relative movement in each movement direction and each rotation direction is enabled, so that mechanisms for enabling the relative movement between the cutting tool 50 and the workpiece 62 are hereinafter collectively referred to as a “feed mechanism”. The control device 100 controls the rotation mechanism for the rotation of the spindle 46 and controls the feed mechanism for the relative movement of the cutting tool 50.

The control device 100 according to the embodiment has a capability of measuring a relative positional relationship between an axis or axis end of the spindle 46 and an object that has been machined with high accuracy into a known shape for positioning. According to the embodiment, the object having a known shape is installed on the workpiece installation surface, and hereinafter, the object is referred to as a “reference block 60”. The control device 100 brings a tool having a known shape attached to the holder 48 into contact with the reference block 60 to measure a relative positional relationship between the rotation axis and the reference block 60. It is therefore preferable that the control device 100 grasp in advance the position where the reference block 60 is installed and the shape of the reference block 60. Note that the object having a known shape is not limited to the reference block 60, and may be, for example, a side surface or upper surface of the first table 16 or the second table 18, or may be a jig installed on the first table 16 or the second table 18.

According to the embodiment, as a tool to be brought into contact with the reference block 60, a tool having no cutting ability, that is, a dummy tool having no cutting edge is used. The control device 100 brings the dummy tool attached to the holder 48 into contact with a reference surface of the reference block 60 to measure the relative positional relationship between the axis or axis end of the spindle 46 and the reference block 60.

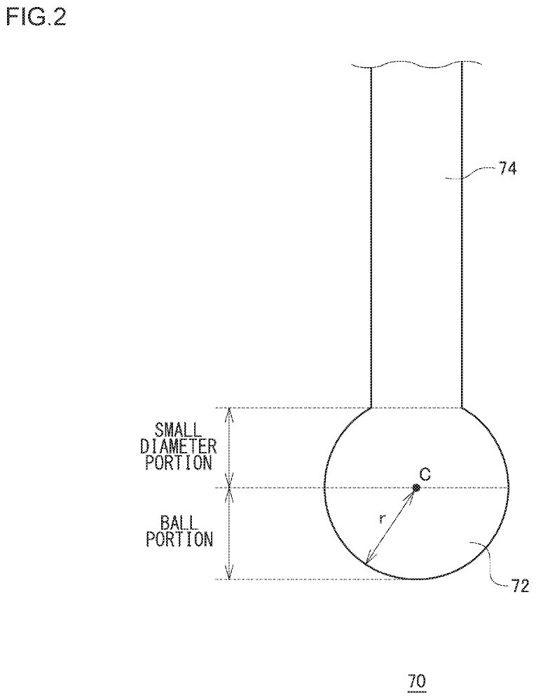

FIG. 2 shows a shape of a tip of the dummy tool. A dummy tool 70 includes a spherical portion 72 having a center c and a cylindrical portion 74 connected to the spherical portion 72. The spherical portion 72 is a spherical component having a spherical shape, and includes a hemispherical ball portion serving as a lower side and a small diameter portion connected to the ball portion. The center c of the spherical portion 72 is located on a center axis of the dummy tool 70. The small diameter portion is circular in cross section orthogonal to a tool axis, and the radius of the circular cross section is smaller than a radius r of the ball portion. The small diameter portion of the spherical portion 72 shown in FIG. 2 has a hemispherical shape having the radius r with a top side removed along a plane orthogonal to the axis, and the cylindrical portion 74 is connected to a surface obtained as a result of removing the top side.

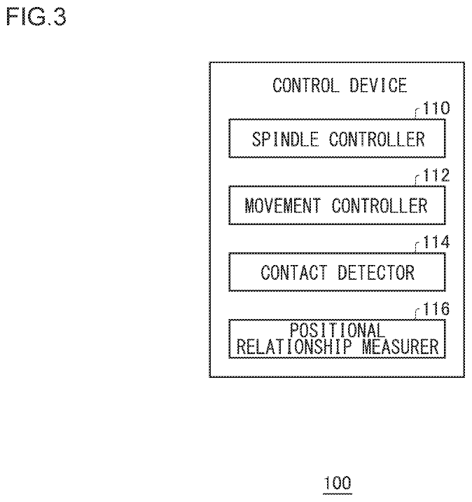

FIG. 3 shows functional blocks of the control device 100. The control device 100 includes a spindle controller 110, a movement controller 112, a contact detector 114, and a positional relationship measurer 116. The spindle controller 110 controls the rotation mechanism for the rotation of the spindle 46, and the movement controller 112 controls the feed mechanism for the relative movement between the dummy tool 70 and the reference block 60.

In FIG. 3, each component described as a functional block that performs various processes can be implemented, in terms of hardware, by a circuit block, a memory, and other LSI and implemented, in terms of software, by a program loaded on the memory and the like. Therefore, it is to be understood by those skilled in the art that these functional blocks may be implemented in various forms such as hardware only, software only, or a combination of hardware and software, and how to implement the functional blocks is not limited to any one of the above.

The contact detector 114 detects contact between the dummy tool 70 and the reference block 60. The contact detector 114 may include a contact sensor that detects contact of the dummy tool 70 with the reference block 60. The contact sensor may be, for example, a force sensor that detects a force applied at the time of contact, or a sensor that detects continuity when the dummy tool 70 and the reference block 60 come into contact with each other.

Note that the machining apparatus 1 according to the embodiment may have a capability of detecting contact between the dummy tool 70 and the reference block 60 by analyzing internal information on the machining apparatus 1 that changes when the dummy tool 70 comes into contact with the reference block 60. For example, when a detection value (such as a current measurement value, a current command value, a position deviation, a torque command value, or a torque estimation value) related to the control of the motor included in the feed mechanism is used as the internal information, it is not necessary to add a new component for contact detection. When the machining apparatus 1 has the capability of detecting contact based on the internal information, a contact detection sensor is not necessary but may be provided for the purpose of increasing detection accuracy.

A description will be given below of a method for causing the control device 100 to detect contact between the dummy tool 70 and the reference block 60 by analyzing the internal information on the machining apparatus 1. The control device 100 according to the embodiment drives and controls the motors of the feed mechanism to make the relative movement between the dummy tool 70 and the reference block 60. With the machining apparatus 1 having a torque estimation capability, when the dummy tool 70 and the reference block 60 come into contact with each other, a motor torque estimation value rapidly increases due to a load generated by the contact. Therefore, the control device 100 may detect, based on a motor torque waveform obtained when the dummy tool 70 and the reference block 60 come close to each other and come into contact with each other, the contact between the dummy tool 70 and the reference block 60.

Note that the feed mechanism is made up of mechanical elements such as a ball screw mechanism, the feed mechanism inevitably has mechanical resistance. Therefore, the motor torque waveform of the feed mechanism contains a small-amplitude fluctuation component generated under the influence of mechanical resistance. This fluctuation component contains a periodic component and aperiodic component generated in a manner that depends on an angular position (rotational angular position) of a screw shaft or bearing, a translational position of a linear guide, and a revolution position and rotation position of rolling elements in the ball screw, bearing, and linear guide. The fluctuation generated by the mechanical resistance of such elements is basically due to an error in shape of each guide surface and each rolling element and thus depends on the position of the feed mechanism. Therefore, when the contact between the dummy tool 70 and the reference block 60 is detected based on a change in the torque detection values, it is preferable that a torque fluctuation component generated by the mechanical resistance be removed from the acquired motor torque waveform at each feed position.

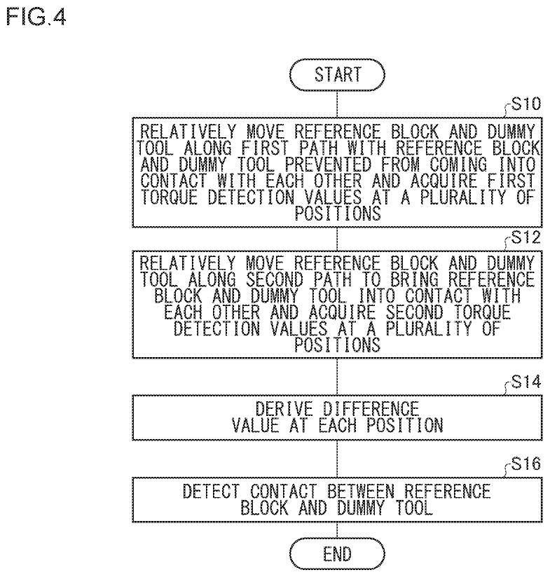

FIG. 4 shows an example of a flowchart for detection of the contact between the dummy tool 70 and the reference block 60. First, the movement controller 112 moves the reference block 60 or the dummy tool 70 along a first path with the reference block 60 and the dummy tool 70 prevented from coming into contact with each other, and the contact detector 114 acquires first torque detection values of the motor included in the feed mechanism at a plurality of feed positions on the first path (S10).

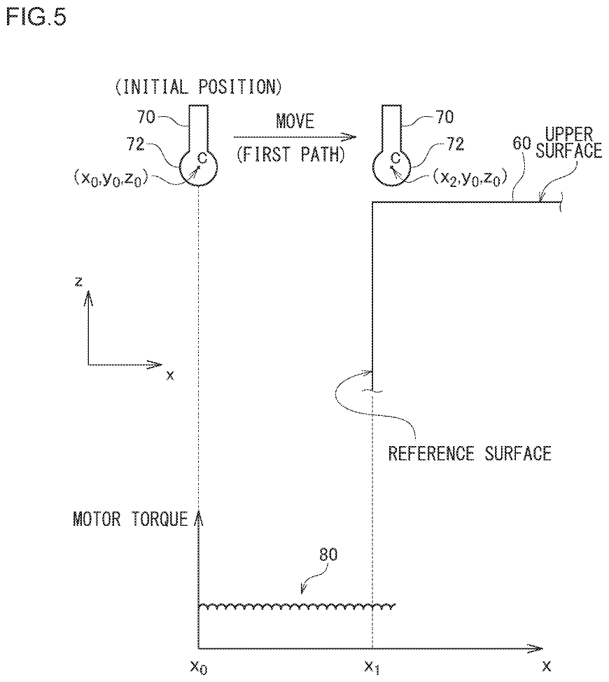

FIG. 5 is a diagram for describing step S10. In the following example, the reference block 60 has a known cuboid shape and has at least a reference surface vertically extending and an upper surface serving as a top portion. For the sake of simplicity, FIG. 5 shows how the reference block 60 is secured, and the dummy tool 70 is moved toward the reference block 60, or alternatively, the reference block 60 may be moved toward the dummy tool 70 with the dummy tool 70 secured. Note that, in the schematic structure of the machining apparatus 1 shown in FIG. 1, the X-axis motor 20 moves the second table 18 in the X-axis direction, and the X-axis sensor 30 detects the position of the second table 18 in the X-axis direction, but in the following example, the X-axis motor 20 moves the spindle 46 in the X-axis direction, and the X-axis sensor 30 detects the position of the spindle 46 in the X-axis direction.

The movement controller 112 sets, on condition that the dummy tool 70 is moved in the X-axis direction, an initial position (x₀, y₀, z₀) of the center c of the spherical portion 72 for the first path as follows:

x₀: a value of a coordinate separate, in the X-axis negative direction, from a coordinate value x₁ where the reference surface is located;

y₀: a coordinate value that coincides with a width position of the reference surface on the Y axis; and

z₀: a coordinate value higher in level than the upper surface of the reference block by at least the radius r of the spherical portion 72;

Specifically, z₀ is represented as follows:

z₀> (the level of the upper surface of the reference block)+(the radius r of the spherical portion 72).

The movement controller 112 sets an end position (x₂, y₀, z₀) of the first path at a position where a part or all of the spherical portion 72 is located over the upper surface of the reference block 60 when viewed in the z-axis direction. In this example, at least
x₂>x₁−(the radius r of the spherical portion 72) needs to be satisfied.

The movement controller 112 sets the center c of the spherical portion 72 at the initial position (x₀, y₀, z₀) based on the detection values of the X-axis sensor 30, the Y-axis sensor 32, and the Z-axis sensor 34, and moves the dummy tool 70 to the end position (x₂, y₀, z₀) of the first path at a predetermined movement speed (velocity). Since the level of the spherical portion center c is maintained at z₀ during the movement along the first path, the spherical portion 72 passes above the upper surface without coming into contact with the reference surface.

The contact detector 114 acquires the first torque detection values of the X-axis motor 20 included in the feed mechanism at a plurality of feed positions on the first path. In FIG. 5, a first torque waveform 80 indicates the first torque detection values of the X-axis motor 20 acquired in association with x-coordinate values at a predetermined sampling period (sampling rate) while the dummy tool 70 is moving along the first path. The x-coordinate value is derived from the detection value of the X-axis sensor 30. As described above, since the ball screw, the bearing supporting the ball screw, the linear guide mechanism, a coupling, and the like included in the feed mechanism have mechanical resistance, the first torque waveform 80 contains a small-amplitude fluctuation component generated by the mechanical resistance. The contact detector 114 records the coordinate values of the spherical portion center c and the first torque detection values in a recording unit (not shown) with the coordinate values and the first torque detection values associated with each other.

Next, referring to FIG. 4, the movement controller 112 moves the reference block 60 or the dummy tool 70 along a second path substantially parallel to the first path so as to bring the reference block 60 and the dummy tool 70 into contact with each other, and the contact detector 114 acquires second torque detection values of the motor included in the feed mechanism at a plurality of feed positions on the second path (S12).

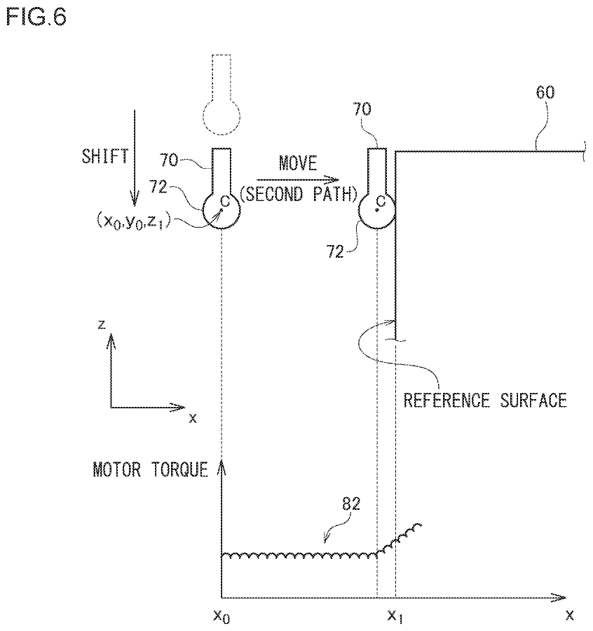

FIG. 6 is a diagram for describing step S12. Subsequent to step S10, the movement controller 112 moves the center c of the spherical portion 72 of the dummy tool 70 to an initial position (x₀, y₀, z₁) of the second path to start step S12. The initial position of the second path is different in z-coordinate value from the initial position (x₀, y₀, z₀) of the first path in step S10. In the initial position of the second path, z₁ is set as follows:

z₁: a coordinate value lower in level than the upper surface of the reference block by at least the radius r of the spherical portion 72.

That is, z₁ is represented as follows:

z₁<(the level of the upper surface of the reference block)−(the radius r of the spherical portion 72).

The movement controller 112 may set an end position of the second path at a position (x₂, y₀, z₁) shifted in the Z-axis direction from the end position (x₂, y₀, z₀) of the first path. Unlike step S10, the reference block 60 and the dummy tool 70 come into contact with each other in step S12, so that it may be undesirable that the torque control be performed to continue the movement after the contact. Therefore, the movement controller 112 may set the end position of the second path at a coordinate value (x₃, y₀, z₁), where

x₃>x₁−(the radius r of the spherical portion 72), and

x₂>x₃.

The movement controller 112 sets the center c of the spherical portion 72 at the initial position (x₀, y₀, z₁) based on the detection values of the X-axis sensor 30, Y-axis sensor 32, and Z-axis sensor 34, and moves the dummy tool 70 to the end position of the second path at a movement speed equal to the movement speed in step S10. Since the second path has the level of the spherical portion center c maintained at z₁, the spherical portion 72 comes into contact with the reference surface.

Note that the movement controller 112 may forcibly terminate the movement of the dummy tool 70 before reaching the end position of the second path. For example, a threshold for termination of movement may be set for the motor torque value, and the movement controller 112 may forcibly stop the feeding mechanism at the moment when the motor torque value exceeds the threshold to terminate the relative movement along the second path.

The contact detector 114 acquires the second torque detection values of the X-axis motor 20 included in the feed mechanism at a plurality of feed positions on the second path. In FIG. 6, a second torque waveform 82 indicates the second torque detection values of the X-axis motor 20 acquired in association with an x-coordinate value at the predetermined sampling period while the dummy tool 70 is moving along the second path. The x-coordinate value is derived from the detection value of the X-axis sensor 30. The contact detector 114 records the coordinate values of the spherical portion center c and the second torque detection values in the recording unit (not shown) with the coordinate values and the second torque detection values associated with each other.

As shown in FIG. 6, the dummy tool 70 cannot move any more after coming into contact with the reference block 60, but elastic deformation of the dummy tool 70 or the like causes the X-axis sensor 30 to output detection values indicating that the spherical portion center c is moving. At this time, a load at the contact point increases, and the motor torque rapidly increases accordingly. Therefore, specifying an x-coordinate value at which the motor torque begins to rapidly increase can derive the x-coordinate value of the spherical portion center c at the time of the contact, but, as shown in FIG. 6, the second torque waveform 82 contains a fluctuation component generated by the mechanical resistance, so that it is difficult to specify the accurate contact timing and accurate contact position from the second torque waveform 82.

Therefore, the contact detector 114 uses the first torque waveform 80 acquired in step S10 to perform a process of removing the fluctuation component generated by the mechanical resistance from the second torque waveform 82 acquired in step S12.

The contact detector 114 derives a difference value between the first detection value and the second detection value acquired at each of the corresponding feed positions on the first path and the second path (S14). The corresponding feed positions are positions where the operation states of the feed mechanism are synchronized, specifically, positions where the x-coordinate values are the same. Therefore, the contact detector 114 reads the second torque detection value and the first torque detection value associated with the same x-coordinate value from the recording unit (not shown) and derives the difference value.

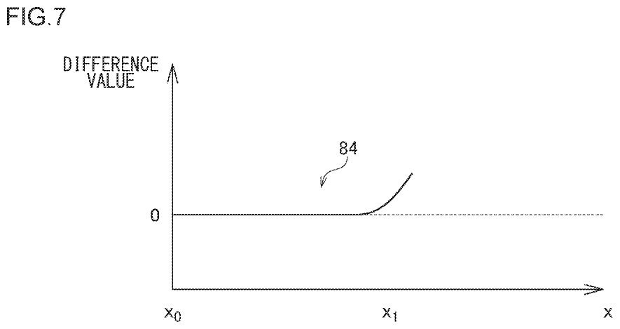

FIG. 7 shows a difference waveform 84 obtained as a result of subtracting the first torque waveform 80 from the second torque waveform 82. The difference waveform 84 is generated from a set of the difference values derived based on the plurality of x-coordinate values. Since the operation states of the feed mechanism on the first path and the second path are the same before the contact, the torque waveforms containing the fluctuation component generated by the mechanical resistance coincide with each other, and thus the difference waveform 84 indicates a value substantially equal to 0. On the other hand, at an x position after the reference block 60 and the dummy tool 70 come into contact with each other on the second path, the difference value changes from 0 due to the generation of the contact load. Therefore, the contact detector 114 can detect the contact between the dummy tool 70 and the reference block 60 based on a change in difference value of the difference waveform 84 (S16).

For example, the contact detector 114 may detect the contact between the dummy tool 70 and the reference block 60 at a timing when the difference value exceeds a predetermined threshold. Since the difference waveform 84 has the amplitude component generated by the mechanical resistance removed, the increase in the motor torque due to the contact is reproduced with high accuracy, so that the contact detector 114 can accurately derive the x-coordinate value of the spherical portion center c when the dummy tool 70 and the reference block 60 come into contact with each other.

Note that the contact detector 114 can also detect the contact between the dummy tool 70 and the reference block 60 using the method disclosed in WO 2020/174585 A. Specifically, the contact detector 114 may detect the contact and specify the contact position based on a mean value of a plurality of difference values acquired before the contact and a regression equation obtained by regression analysis of a plurality of difference values acquired after the contact.

In the above-described example, step S10 is executed before step S12, but the execution order may be changed. A first torque waveform 80 obtained by averaging results of step S10 executed a plurality of times may be used. Further, according to the embodiment, the torque detection value estimated by the torque estimation capability of the machining apparatus 1 is used as the detection value related to the control of the motor included in the feed mechanism, whereas, in the machining apparatus 1 having no torque estimation capability, the contact detection may be made using a detection value such as a motor current measurement value related to the control of the motors.

In the above-described example, the relative positional relationship between the rotation axis and the reference block 60 is determined by relatively moving the dummy tool 70 and the reference block 60 in a direction orthogonal to the rotation axis of the spindle 46 to detect the contact. In another example, the relative positional relationship between the axis end of the spindle 46 and the reference block 60 may be determined by relatively moving the dummy tool 70 and the reference block 60 in a direction parallel to the rotation axis of the spindle 46 to detect the contact between the upper surface of the reference block 60 and the dummy tool 70 (whose projection length is known).

As described above, the contact detector 114 can detect the contact between the dummy tool 70 and the reference block 60 to specify the contact position. Note that the contact detector 114 may include a contact sensor to detect the contact based on sensing data from the contact sensor and acquire a coordinate value at the time of the contact. A description will be given below of a method for causing the positional relationship measurer 116 to measure a relative positional relationship between the axis of the spindle 46 and the reference block 60 on condition that the contact detector 114 has a capability of detecting contact with high accuracy. According to this method, when the dummy tool 70 is eccentrically attached to the spindle 46, the relative positional relationship is determined with the influence of the eccentricity removed.

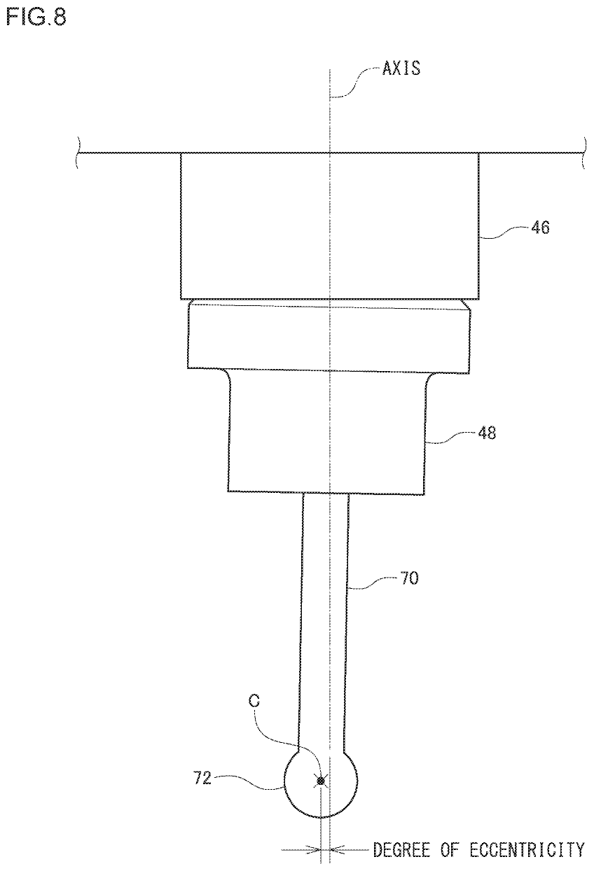

FIG. 8 shows a state where the dummy tool 70 is attached to the holder 48. In an ideal attachment state, the axis of the spindle 46 and the center axis of the dummy tool 70 coincide with each other, whereas, in an actual attachment state, the axis of the spindle 46 and the center axis of the dummy tool 70 often do not coincide with each other due to an error in shape, securing position, deformation, or the like of each component. In the attachment state shown in FIG. 8, the center c of the spherical portion 72 is eccentric from the axis of the spindle 46. A description will be given below of a method for accurately measuring the relative positional relationship between the axis of the spindle 46 and the reference block 60 even when the spherical portion center c is eccentric from the axis of the spindle 46.

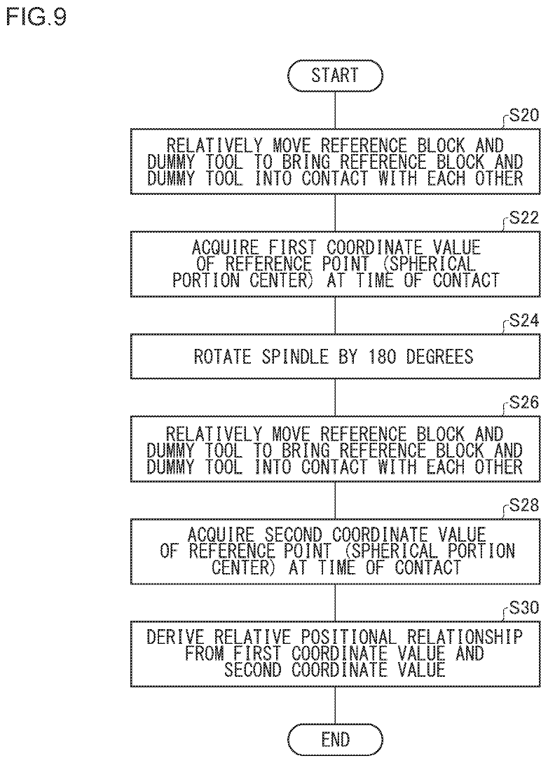

FIG. 9 shows an example of a flowchart for measurement of the relative positional relationship between the axis of the spindle 46 and the reference block 60. According to an example of the measurement method, contact is made twice with the spindle 46 changed in angular position each time. The angular position of the spindle 46 may be detected by the spindle sensor 42 as a rotational angular position relative to a predetermined origin point.

First Contact

First, the movement controller 112 moves the dummy tool 70 relative to the reference block 60 to bring the reference block 60 and the dummy tool 70 into contact with each other (S20). The contact detector 114 acquires a first coordinate value of a reference point when the reference block 60 and the dummy tool 70 come into contact with each other (S22). According to the embodiment, the reference point is the center c of the spherical portion 72, but another position in the dummy tool 70 may be used as the reference point.

### Second Contact

Subsequently, the spindle controller 110 rotates the spindle 46 by 180 degrees about the axis from the angular position of the spindle 46 set at the time of the first contact (S24). Then, the movement controller 112 moves the dummy tool 70 relative to the reference block 60 to bring the reference block 60 and the dummy tool 70 into contact with each other (S26). The contact detector 114 acquires a second coordinate value of the reference point when the reference block 60 and the dummy tool 70 come into contact with each other (S28).

After the first contact and the second contact, the positional relationship measurer 116 derives the relative positional relationship between the axis of the spindle 46 and the reference block 60 from the first coordinate value and the second coordinate value (S30). A description will be given below of the measurement method according to the embodiment with reference to a specific example.

### Relative Positional Relationship Between Axis and Reference Surface

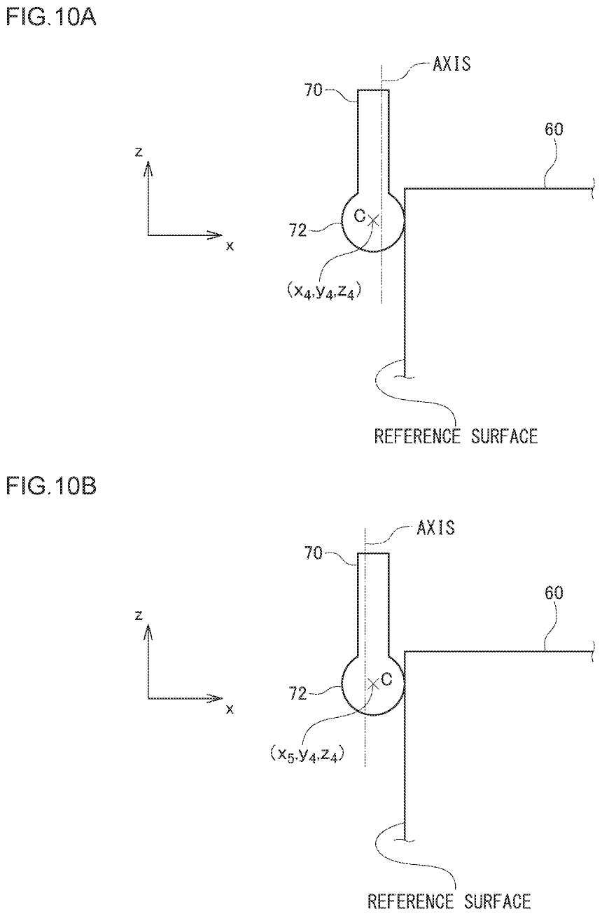

FIG. 10A shows a state of the first contact. To make the first contact, the movement controller 112 moves the dummy tool 70 in the X-axis direction relative to the reference surface of the reference block 60 to bring the spherical portion 72 of the dummy tool 70 into contact with the reference surface of the reference block 60. The contact detector 114 acquires the first coordinate value (x₄, y₄, z₄) of the spherical portion center c. The position x₄ acquired as the x-coordinate value of the spherical portion center c is the x position of the spindle 46 detected by the X-axis sensor 30, and the contact detector 114 obtains the x position of the spherical portion center c on condition that the x position of the spindle 46 coincides with (is not eccentric from) the x position of the spherical portion center c. Therefore, when the spherical portion center c is eccentric from the axis of the spindle in the X-axis direction, the position x₄ of the spherical portion center c thus acquired is different from the actual x position by the degree of eccentricity.

FIG. 10B shows a state of the second contact. To make the second contact, after the spindle controller 110 rotates the spindle 46 by 180 degrees about the axis from the angular position of the spindle 46 set at the time of the first contact, the movement controller 112 moves the dummy tool 70 in the X-axis direction relative to the reference surface of the reference block 60 to bring the spherical portion 72 of the dummy tool 70 into contact with the reference surface of the reference block 60. The path of movement of the spherical portion center c for the second contact is the same as the path of movement of the spherical portion center c for the first contact. The contact detector 114 acquires the second coordinate value (x₅, y₄, z₄) of the spherical portion center c. As described above, the position x₅ acquired as the x-coordinate value of the spherical portion center c is actually the same as the x-position of the spindle 46 detected by the X-axis sensor 30.

The positional relationship measurer 116 derives a relative positional relationship between a coordinate value between the first coordinate value and the second coordinate value and the reference surface. Specifically, the positional relationship measurer 116 derives a relative positional relationship between a coordinate value at a midpoint between the first coordinate value and the second coordinate value and the reference surface. The coordinate value of the midpoint is obtained as follows:

coordinate value of midpoint ((x₄+x₅)/2, y₄, z₄).

The positional relationship measurer 116 may determine the x-coordinate value (x₄+x₅)/2 as the x position of the axis of the spindle 46 relative to the reference surface. As described above, the second contact with the spindle 46 rotated by 180 degrees allows the relative positional relationship between the axis of the spindle 46 and the reference block 60 to be accurately determined with the influence of the eccentricity of the spherical portion 72 removed. In the above-described example, the coordinate value of the midpoint is obtained, but the positional relationship measurer 116 may derive a center position between at least two coordinate values in the movement direction (X-axis direction).

In the above-described example, the movement controller 112 makes contact twice, and the positional relationship measurer 116 derives the relative positional relationship between the axis and the reference block 60 from the coordinate values of the spherical portion center c obtained by the two times of contact. In another example, the movement controller 112 may make contact at least three times, and the positional relationship measurer 116 may derive the relative positional relationship between the axis and the reference block 60 from at least three coordinate values. The greater the number of times of contact, the higher the accuracy of the derivation of the relative positional relationship.

Specifically, the movement controller 112 moves the dummy tool 70 in the X-axis direction relative to the reference surface of the reference block 60 with the spindle 46 set at a plurality of different angular positions to bring the spherical portion 72 of the dummy tool 70 into contact with the reference surface of the reference block 60. After bringing the spherical portion 72 into contact with the reference block 60, the movement controller 112 moves the spherical portion 72 away from the reference block 60, the spindle controller 110 rotates the spindle 46 by N degrees about the axis from a corresponding angular position of the spindle 46, and then the movement controller 112 brings the spherical portion 72 into contact with the reference block 60 again. As described above, before this contact, the spindle controller 110 rotates the spindle 46 by N degrees about the axis from the angular position of the spindle 46 set at the time of the previous contact, and the movement controller 112 brings the spherical portion 72 into contact with the reference block 60 with the spindle 46 set at a plurality of different angular positions. The movement controller 112 may bring the reference block 60 and the spherical portion 72 into contact with each other at least (360/N) times while changing the angular position of the spindle 46. Herein, a rotation angle N is set such that (360/N) results in an integer.

The contact detector 114 acquires coordinate values of the spherical portion center c when the spherical portion 72 and the reference surface of the reference block 60 come into contact with each other with the spindle 46 set at the different angular positions. The positional relationship measurer 116 derives the relative positional relationship between the rotation axis and the reference block 60 from the plurality of coordinate values acquired by the contact detector 114. Note that the positional relationship measurer 116 may derive a relative positional relationship between a mean value of the plurality of coordinate values and the reference surface.

### Relative Positional Relationship Between Axis and Center Between Two Opposite Reference Surfaces

In this example, the reference block 60 has a first reference surface and a second reference surface on an opposite side from the first reference surface. As described above, the reference block 60 has a cuboid shape, and the first reference surface and the second reference surface plane are thus parallel to each other.

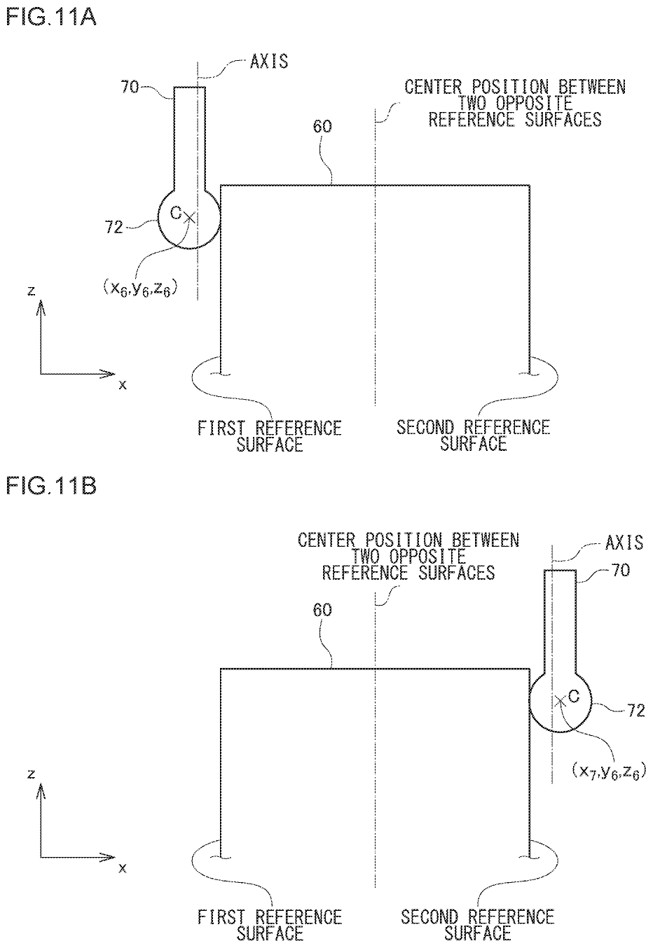

FIG. 11A shows a state of first contact. To make the first contact, the movement controller 112 moves the dummy tool 70 in the X-axis positive direction relative to the first reference surface of the reference block 60 to bring the spherical portion 72 of the dummy tool 70 into contact with the first reference surface of the reference block 60. The contact detector 114 acquires a first coordinate value (x₆, y₆, z₆) of the spherical portion center c. Herein, the position x₆ acquired as the x-coordinate value of the spherical portion center c is actually the same as the x-position of the spindle 46 detected by the X-axis sensor 30.

FIG. 11B shows a state of second contact. To make the second contact, after the spindle controller 110 rotates the spindle 46 by 180 degrees about the axis, the movement controller 112 moves the dummy tool 70 in the X-axis negative direction relative to the second reference surface of the reference block 60 to bring the spherical portion 72 of the dummy tool 70 into contact with the second reference surface of the reference block 60. The movement direction of the spherical portion center c for the second contact is opposite to the movement direction of the spherical portion center c for the first contact. The contact detector 114 acquires a second coordinate value (x₇, y₆, z₆) of the spherical portion center c.

The positional relationship measurer 116 derives a relative positional relationship between the axis of the spindle 46 and a position between the first reference surface and the second reference surface. Specifically, the positional relationship measurer 116 derives a relative positional relationship between the axis of the spindle 46 and the center position between the first reference surface and the second reference surface. The x-coordinate value of the center position is obtained as follows:

x-coordinate value of center position (x₆+x₇)/2.

The control device 100 may determine the x-coordinate value (x₆+x₇)/2 as the center position of the reference block 60 in the X-axis direction. As described above, the second contact with the spindle 46 rotated by 180 degrees allows the relative positional relationship between the axis of the spindle 46 and the reference block 60 to be accurately determined with the influence of the eccentricity of the spherical portion 72 removed.

The present disclosure has been described on the basis of the embodiment. It is to be understood by those skilled in the art that the embodiment is illustrative and that various modifications are possible for a combination of components or processes, and that such modifications are also within the scope of the present disclosure. According to the embodiment, the dummy tool 70 is brought into contact with the reference block 60 having a known shape, but may be brought into contact with the workpiece 62.

According to the embodiment, the dummy tool 70 having no cutting ability is used as the tool to be brought into contact with the reference block 60, or alternatively, a rotary tool may be used. The rotary tool may be, for example, a ball end mill having a hemispherical ball portion, and when the ball end mill is used, the method for measuring the relative positional relationship described with reference to FIGS. 11A and 11B can be applied.

When a cutting edge portion of the rotary tool is brought into contact, it is difficult to specify an angular position (rotational angular position) at the time of contact, and it is therefore desirable to bring the cutting edge portion into contact while rotating the rotary tool forward or backward at a rotary speed higher enough than the velocity of the relative movement. Since the cutting edge portion has cutting ability when rotating forward and generates scratch marks when rotating backward, it is preferable that an object with which the rotary tool comes into contact be an object such as the workpiece 62 that is allowed to be cut (or allowed to have scratch marks) rather than the reference block 60.

Note that the rotary tool has a base portion having a cylindrical surface or a conical surface with not cutting edge, and the base portion may be brought into contact with the reference block 60 or the workpiece 62.

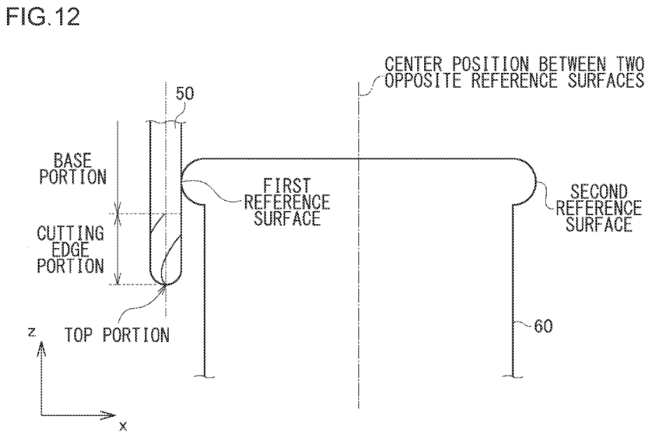

FIG. 12 shows how the base portion of the rotary tool is brought into contact with the reference surface of the reference block 60. When the base portion of the rotary tool is brought into contact with the reference surface, the spindle 46 need not be rotated because the base portion has a cylindrical surface or a conical surface unlike the cutting edge portion. When the contact surface of the tool is a cylindrical surface or a conical surface as described above, it is desirable that the contact surface of the reference block 60 or workpiece 62 have a convex portion gently curved in a direction in which the tool relatively moves in order to prevent the contact point from becoming a sharp corner.

Further, even when the ball end mill is moved in parallel with the rotation axis direction to be brought into contact with the upper surface (reference surface) perpendicular to the axis direction, the top portion (vertex position or the vicinity of the vertex position) of the ball end mill is always brought into contact with the upper surface, so that it is not necessary to rotate the spindle 46.

The outline of an aspect of the present disclosure is as follows. A positional relationship measurement method according to one aspect of the present disclosure is a method for measuring a relative positional relationship between an axis of a spindle and an object, the method including a moving step of moving a tool attached to the spindle relative to the object to bring the object and the tool into contact with each other, a coordinate value acquiring step of acquiring a coordinate value of a reference point when the object and the tool come into contact with each other, and a measuring step of deriving the relative positional relationship between the axis and the object from the coordinate value thus acquired. The moving step brings the object and the tool into contact with each other with the spindle set at different angular positions, the coordinate value acquiring step acquires the coordinate value of the reference point when the object and the tool come into contact with each other with spindle set at the different angular positions, and the measuring step derives the relative positional relationship between the axis and the object from the plurality of coordinate values thus acquired.

According to this aspect, even when the tool is eccentrically attached to the spindle, it is possible to measure the relative positional relationship between the axis of the spindle and the object with the influence of the eccentricity removed.

The moving step may include at least a first moving step of moving the tool attached to the spindle relative to the object to bring the object and the tool into contact with each other, and a second moving step of rotating the spindle by N degrees about the axis from the angular position of the spindle set in the first moving step, and then moving the tool relative to the object to bring the object and the tool into contact with each other. The moving step may bring the object and the tool into contact with each other at least (360/N) times. The rotation angle N is set such that (360/N) results in an integer.

The object may have one reference surface, the moving step may bring the tool into contact with the reference surface of the object, and the measuring step may derive a relative positional relationship between a mean value of the plurality of coordinate values and the reference surface. The object may have a first reference surface and a second reference surface on an opposite side from the first reference surface, the first moving step may bring the tool into contact with the first reference surface of the object, the second moving step may bring the tool into contact with the second reference surface of the object, and the measuring step may derive a relative positional relationship between the axis and a position between the first reference surface and the second reference surface. The relative positional relationship between the axis and the position between the first reference surface and the second reference surface can be derived by bringing the tool into contact with the two opposite reference surfaces to acquire the coordinate values of the reference points. The measuring step may derive a relative positional relationship between the axis and a center position between the first reference surface and the second reference surface.

The tool may have a spherical component, and the spherical component may come into contact with the object. Further, the tool may be a rotary tool such as an end mill, and a base portion having a cylindrical surface or a conical surface or a rotating cutting edge portion may come into contact with the object. When the base portion and the object come into contact with each other, the base portion need not be rotated.

A machining apparatus according to another aspect of the present disclosure includes a rotation mechanism structured to rotate a spindle to which a tool is attached, a feed mechanism structured to move the tool relative to an object, and a control device structured to control the rotation of the spindle by the rotation mechanism and the relative movement of the tool by the feed mechanism. The control device brings the object and the tool into contact with each other with the spindle set at different angular positions, acquires the coordinate value of the reference point when the object and the tool come into contact with each other, and derives the relative positional relationship between the axis and the object from the plurality of coordinate values thus acquired.

According to this aspect, even when the tool is eccentrically attached to the spindle, it is possible to measure the relative positional relationship between the axis of the spindle and the object with the influence of the eccentricity removed.

A contact detection method according to still another aspect of the present disclosure is a method for detecting contact between a tool attached to a spindle and an object, the method including a first acquiring step of acquiring first detection values related to control of a motor included in a feed mechanism at a plurality of positions on a first path by moving the object or the tool along the first path with the object and the tool prevented from coming into contact with each other, a second acquiring step of acquiring second detection values related to the control of the motor included in the feed mechanism at a plurality of positions on a second path substantially parallel to the first path by moving the object or the tool along the second path to bring the object and the tool into contact with each other, a deriving step of deriving a difference value between the first detection value and the second detection value acquired at each of corresponding positions on the first path and the second path, and a detecting step of detecting contact between the tool and the object based on changes in the difference values derived for the plurality of positions. According to this aspect, the contact between the tool and the object can be detected with high accuracy.

In the contact detection method, each of the first detection value and the second detection value may contain a fluctuation component generated by mechanical resistance of the feed mechanism. A movement speed in the first acquiring step and a movement speed in the second acquiring step may be equal to each other. The second path ends before a position corresponding to an end position of the first path. In the second acquiring step, when the second detection value exceeds a threshold for termination of movement, the movement along the second path may be terminated.

A machining apparatus according to yet another aspect of the present disclosure includes a feed mechanism structured to move a tool relative to an object and a control device structured to control the relative movement of the tool by the feed mechanism, and the control device acquires a first detection value related to control of a motor included in the feed mechanism at a plurality of positions on a first path by moving the object or the tool along the first path with the object and the tool prevented from coming into contact with each other, acquires a second detection value related to the control of the motor included in the feed mechanism at a plurality of positions on a second path substantially parallel to the first path by moving the object or the tool along the second path to bring the object and the tool into contact with each other, derives a difference value between the first detection value and the second detection value acquired at each of corresponding positions on the first path and the second path, and detects contact between the tool and the object based on changes in the difference value derived for the plurality of positions. According to this aspect, the contact between the tool and the object can be detected with high accuracy.

A positional relationship measurement method according to yet another aspect of the present disclosure is a method for measuring a relative positional relationship between an axis of a spindle and an object, the method including a moving step of moving a tool attached to the spindle relative to the object to bring the object and the tool into contact with each other with the spindle set at different angular positions, a coordinate value acquiring step of acquiring a coordinate value of a reference point when the object and the tool come into contact with each other with the spindle set at the different angular positions, and a measuring step of deriving the relative positional relationship between the axis and the object from the plurality of coordinate values thus acquired. The moving step may include at least a first moving step of moving the tool attached to the spindle relative to the object to bring the object and the tool into contact with each other, a second moving step of rotating the spindle by N degrees about the axis from the angular position of the spindle set in the first moving step, and then moving the tool relative to the object to bring the object and the tool into contact with each other, and a third moving step of rotating the spindle by N degrees about the axis from the angular position of the spindle set in the second moving step, and then moving the tool relative to the object to bring the object and the tool into contact with each other.

The moving step may bring the object and the tool into contact with each other at least (360/N) times (360/N is an integer). In the positional relationship measurement method, the object may have one reference surface, the moving step may bring the tool into contact with the reference surface of the object with the spindle set at different angular positions, and the measuring step may derive a relative positional relationship between a mean value of the plurality of coordinate values and the reference surface.

A positional relationship measurement method according to yet another aspect of the present disclosure is a method for measuring a relative positional relationship between an axis of a spindle and an object, the method including a moving step of moving a tool attached to the spindle relative to the object to bring the object and the tool into contact with each other with the spindle set at different angular positions, a coordinate value acquiring step of acquiring a coordinate value of a reference point when the object and the tool come into contact with each other with the spindle set at the different angular positions, and a measuring step of deriving the relative positional relationship between the axis and the object from the plurality of coordinate values thus acquired. The tool may be a rotary tool, and a base portion having a cylindrical surface or a conical surface and the object may come into contact with each other.

In the positional relationship measurement method, the object may have one reference surface, the moving step may bring the base portion of the rotary tool into contact with the reference surface of the object with the spindle set at different angular positions, and the measuring step may derive a relative positional relationship between a mean value of the plurality of coordinate values and the reference surface. The reference surface may have a convex portion curved in a direction in which the base portion of the rotary tool relatively moves for contact, and the base portion of the rotary tool may come into contact with the convex portion.

A machining apparatus according to yet another aspect of the present disclosure includes a rotation mechanism structured to rotate a spindle to which a tool is attached, a feed mechanism structured to move the tool relative to an object, and a control device structured to control the rotation of the spindle by the rotation mechanism and the relative movement of the tool by the feed mechanism. The control device brings the object and the tool into contact with each other with the spindle set at different angular positions, acquires a coordinate value of a reference point when the object and the tool come into contact with each other, and derives a relative positional relationship between a rotation axis and the object from the plurality of coordinate values thus acquired. This control device may perform at least a first moving process of moving the tool attached to the spindle relative to the object to bring the object and the tool into contact with each other, a second moving process of rotating the spindle by N degrees about the rotation axis from the angular position of the spindle set in the first moving process, and then moving the tool relative to the object to bring the object and the tool into contact with each other, and a third moving process of rotating the spindle by N degrees about the rotation axis from the angular position of the spindle set in the second moving process, and then moving the tool relative to the object to bring the object and the tool into contact with each other.

A machining apparatus according to yet another aspect of the present disclosure includes a rotation mechanism structured to rotate a spindle to which a tool is attached, a feed mechanism structured to move the tool relative to an object, and a control device structured to control the rotation of the spindle by the rotation mechanism and the relative movement of the tool by the feed mechanism. The control device brings the object and the tool into contact with each other with the spindle set at different angular positions, acquires a coordinate value of a reference point when the object and the tool come into contact with each other, and derives a relative positional relationship between a rotation axis and the object from the plurality of coordinate values thus acquired. The tool may be a rotary tool, and the control device may bring a base portion of the rotary tool having a cylindrical surface or a conical surface and the object into contact with each other.

What is claimed is:

1. A contact detection method for detecting contact between a tool attached to a spindle and an object, the contact detection method comprising:
acquiring first detection values related to control of a motor included in a feed mechanism at a plurality of positions on a first path by moving the object or the tool along the first path with the object and the tool prevented from coming into contact with each other;
acquiring second detection values related to the control of the motor included in the feed mechanism at a plurality of positions on a second path substantially parallel to the first path by moving the object or the tool along the second path to bring the object and the tool into contact with each other;
deriving a difference value between the first detection value and the second detection value acquired at each of corresponding positions on the first path and the second path; and
detecting contact between the tool and the object based on changes in the difference values derived for the plurality of positions.

2. The contact detection method according to claim 1, wherein
each of the first detection value and the second detection value contains a fluctuation component generated by mechanical resistance of the feed mechanism.

3. The contact detection method according to claim 1, wherein
a movement speed when acquiring the first detection values and a movement speed when acquiring the second detection values are equal to each other.

4. The contact detection method according to claim 1, wherein
the second path ends before a position corresponding to an end position of the first path.

5. The contact detection method according to claim 1, wherein
when the object or the tool is moved along the second path substantially parallel to the first path and the second detection value exceeds a threshold for termination of movement, the movement along the second path is terminated.
